(19) United States
(12) Patent Application Publication
(10) Pub. No.: US 2006/0164956 A1
(43) Pub. Date: Jul. 27, 2006

(54) Optical head and disk reproducing apparatus

(75) Inventor: Takaaki Furuya, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/331,539

(22) Filed: Jan. 13, 2006

(30) Foreign Application Priority Data
Jan. 14, 2005 (JP) JP 2005-008245

(51) Int. Cl. G11B 7/00

(52) U.S. Cl. 369/112.02; 369/112.01

(57) ABSTRACT

An optical head includes a semiconductor laser element, an objective lens, and a liquid crystal element, a voltage applying section and a control section. The liquid crystal element is provided on an optical path of diffuse light between the semiconductor laser element and the objective lens is divided into a plurality of divisions. The voltage applying section applies a voltage to the plurality of divisions of the liquid crystal element to change the refractive index of the divisions. The control section controls the operation of the voltage applying section which applies a voltage to the divisions of the liquid crystal element to adjust the amount of phase compensation imparted to light incident on each of the divisions of the liquid crystal element such that a spot formed by light transmitted by the liquid crystal element undergoes a phase change that is uniform in the spot.

### BACKGROUND OF THE INVENTION

1. Field of the Invention

The present invention relates to an optical head and a disk reproducing apparatus.

2. Description of the Related Art

Some disk reproducing apparatus are capable of performing recording and/or reproduction on plural types of magneto-optical recording media having different physical formats, i.e., MD (Mini Disc; registered trademark) and Hi-MD (registered trademark) An optical head provided in such a disk reproducing apparatus that performs recording and reproduction on plural types of magneto-optical recording media includes a light source for emitting laser light, an objective lens for converging the laser light emitted by the light source on an information recording surface of a magneto-optical recording medium, an optical system for separating laser light that is return light reflected on the information recording surface of the magneto-optical recording medium, and a signal conversion section for converting the laser light separated by the optical system into an electrical signal.

A magneto-optical recording medium such as an MD or Hi-MD has guide grooves simply referred to as grooves provided on an information recording surface thereof. When the magneto-optical recording medium is reproduced, a disk reproducing apparatus irradiates the grooves with laser light emitted by a light source and reads information recorded in the grooves from a reflection of the irradiating light. Recently, the track pitch of magneto-optical recording media is made smaller for higher density to allow information signals to be recorded on the magneto-optical recording media as much as possible.

MDs used in the related art have a track pitch of 1.6 μm, and Mi-MDs which have recently been developed to allow high density recording have a track pitch of 1.25 μm. EFM (Eight to Fourteen Modulation) data are recorded in the grooves of an MD, and data modulated on the basis of RLL(1-7) PP are recorded in the grooves of a Hi-MD, where RLL stands for “Run Length Limited”, and PP stands for “Parity preserve/Prohibit RMTR (Repeated Minimum Transition Run Length)”, and RLL(1-7) PP is a physical format for recording in a density higher than that on an MD. An optical head including a light source emitting laser light having a wavelength of 780 nm and an objective lens having a numerical aperture (NA) of 0.45 is used in compatibility with both of MDs and Hi-MDs which have different physical formats as thus described.

When such an optical head is used, the diameter of a spot of laser light emitted by the light source can become larger than the track pitch, and the spot diameter can extend beyond a groove. Such a beam of light extending beyond a groove is reflected on the surface of a land adjacent to the groove irradiated with the light, and the reflection can be included in light that is reflected by the groove and converted into an electrical signal. Such a phenomenon is referred to as crosstalk. When light to be converted into an electrical signal includes another beam of light, many errors can be generated in the electrical signal obtained by the conversion, e.g., an information recording/reproduction signal (RF signal), whereby recording and reproduction characteristics can be degraded.

Under the circumstance, proposals have been made on optical heads in which a phase compensation element is inserted in the optical path of light reflected from a magneto-optical recording medium to reduce errors by limiting crosstalk components from the lands and to thereby prevent degradation of recording and reproduction characteristics (for example, see Japanese Unexamined Patent Publication JP-A 2003-296960 (pp. 14-15 and FIG. 16)).

FIG. 13 is a sectional view showing a schematic configuration of a related-art optical head 1. The optical head 1 is disclosed in JP-A 2003-296960. The optical head 1 which is a discrete optical system comprises a semiconductor laser element 2 for emitting laser light, a grating 3 for separating light emitted by the semiconductor laser element 2, a polarization beam splitter 4 for transmitting or reflecting light incident thereon, a collimator lens 5 for converting light incident thereon into parallel light, a phase compensation element 6 for adjusting a phase of light incident thereon, an objective lens 7 for converging laser light on a magneto-optical recording medium 10, a Wollaston prism 8 for separating light incident thereon, and a photodetector 9 for converting light incident thereon into an electrical signal.

The semiconductor laser element 2, which is a light source for emitting light, emits laser light having a wavelength of 780 nm when the magneto-optical recording medium 10 is an MD or Hi-MD for example. The semiconductor laser element 2 is connected to an external circuit (not shown) for supplying a drive current, and the intensity of laser light can be changed by changing the amount of a current from the external circuit.

The grating 3 is a diffraction grating for separating the light emitted by the semiconductor laser element 2 into zero-order diffracted light, −first-order diffracted light and +first-order diffracted light. The polarization beam splitter 4 transmits outgoing light emitted by the semiconductor laser element 2 toward the magneto-optical recording medium 10 and reflects light reflected by the magneto-optical recording medium 10. The collimator lens 5 converts diffuse light emitted by the semiconductor laser element 2 into parallel light which then exits the lens.

The phase compensation element 6 imparts phase compensation to light incident thereon in such an amount that satisfactory recording and reproduction characteristics will be achieved in either of a case wherein the magneto-optical recording medium 10 is an MD and a case wherein the medium is a Hi-MD.

For example, the objective lens 7 has a numerical aperture (NA) of 0.45, and is mounted on an actuator (not shown) for holding the objective lens 7 so as to be capable of being moved in a focus direction which is a direction in parallel with the optical axis of incident light and a track direction which is a direction orthogonal to a radial direction of the magneto-optical recording medium 10. The objective lens 7 converges outgoing light emitted by the semiconductor laser element 2 toward the medium on an information recording surface of the magneto-optical recording medium 10 to form a light spot thereon. The Wollaston prism 8 separates the light entering itself after being reflected by the magneto-optical recording medium 10 and the polarization beam splitter 4, and projects the separated light on the photodetector 9. The photodetector 9 is a signal conversion section which converts the laser light incident thereon into an electrical signal and performs calculations on the signal to output a focus error signal (FE signal), a tracking error signal (TE signal), and an RF signal.

The laser light emitted by the semiconductor laser element 2 is transmitted by the grating 3, the polarization beam splitter 4, the collimator lens 5, and the phase compensation element 6 to enter the objective lens 7, and the light is converged on the information recording surface of the magneto-optical recording medium 10. The laser light converged on the information recording surface of the magneto-optical recording medium 10 is reflected on a reflecting surface of the magneto-optical recording medium 10, transmitted by the objective lens 7, the phase compensation element 6, and the collimator lens 5, reflected by the polarization beam splitter 4, separated by the Wollaston prism 8, and received by the photodetector 9 from which the above-mentioned signals are output.

In the optical head 1 disclosed in JP-A 2003-296960, since the phase of light reflected by the magneto-optical recording medium 10 is properly adjusted by the phase compensation element 6, the phase of light reflected by the lands is adjusted to reduce crosstalk. It is described that the degradation of recording and reproduction characteristics is thus prevented on both of MDs and Hi-MDs.

However, it is required to provide an optimum amount of phase compensation for each of recording/reproduction of an MD and recording/reproduction of a Hi-MD because those magneto-optical recording media have different track pitches. Although the optimum amount of phase compensation for the magneto-optical recording medium 10 varies depending on the physical format of the medium, the optical head 1 disclosed in JP-A 2003-296960 employs the same phase compensation element 6 for recording and reproduction of MDs and Hi-MDs.

In such an optical head 1, the amount of phase compensation is chosen to allow recording and reproduction to be performed as satisfactorily as possible whether the magneto-optical recording medium 10 is an MD or Hi-MD. It is however difficult to set an amount of phase compensation that is optimal for both of an MD and a Hi-MD.

Therefore, there is demand for an optical head in which an optimum amount of phase compensation can be provided at the time of recording and reproduction of each of plural types of magneto-optical recording media to improve the recording and reproduction characteristics of the magneto-optical recording media. Optical heads employing a liquid crystal element as a phase compensation element have been proposed to satisfy such demand. In the liquid crystal element, the refractive index of a liquid crystal changes depending on a voltage applied thereto to impart a phase change to light incident on the element. The amount of phase compensation provided by such a liquid crystal element can be set at an optimum value depending on the voltage applied. The use of such a liquid crystal element as a phase compensation element allows an optimum amount of phase compensation to be imparted at each of recording/reproduction of an MD and recording/reproduction of a Hi-MD.

A collimator lens for converting incident light into parallel light has been generally used as a lens for projecting light on an objective lens of an optical head. Recently, in order to reduce the size of an optical head in the direction of the optical axis of light exiting the same and in the direction of the focus of the objective lens thereof and to improve the intensity of light exiting the objective lens, a coupling lens is frequently used, which changes the diffusing angle of light incident thereon to project the resultant non-parallel light on the objective lens.

However, the use of such a coupling lens results in the following problems. When the angle of incidence of light entering a liquid crystal element changes, the refractive index of the liquid crystal against the incident light changes accordingly. When the refractive index of the liquid crystal against incident light changes as thus described, the amount of a phase change varies depending on the angle of incident of the incident light even if the amount of phase compensation imparted is kept unchanged. As a result, the light undergoes phase changes in different amounts in the vicinity of the optical axis thereof and at the periphery of the light spot.

Therefore, when a coupling lens is used in the optical head, light incident on the liquid crystal element becomes diffuse light, and the diffuse light has different angles of incidence in the vicinity of the center of the light spot and at the periphery of the light spot. As a result, the light is refracted at different refractive indices in the vicinity of the optical axis thereof and at the periphery of the light spot apart from the optical axis. When light has different refractive indices in the vicinity of the optical axis thereof and at the periphery of the light spot apart from the optical axis as thus described, the following problem arises. When diffuse light is made to enter the liquid crystal element using a coupling lens, even if an optimum amount of phase compensation is imparted to the light in the vicinity of the spot of the light during each of recording/reproduction of an MD and recording/reproduction of a Hi-MD, the actual amount of a phase change at the periphery of the light spot will have a value different from the optimum amount of phase compensation, and there will be variation of the amount of phase change in the light spot.

### SUMMARY OF THE INVENTION

An object of the invention is to provide an optical head in which a difference in the amount of phase changes in a light spot attributable to the angle of incidence of the light is reduced to improve recording and reproduction characteristics of an optical recording medium, and a disk reproducing apparatus.

The invention provides an optical head in which an optical recording medium is irradiated with light to record information thereon and/or reproduce information therefrom, comprising:

a light source for emitting light;

an objective lens for converging the light emitted by the light source on an optical recording medium;

a liquid crystal element provided on an optical path of diffuse light between the light source and an objective lens, the liquid crystal element being divided to have a plurality of divisions;

a voltage applying section for applying a voltage to the plurality of divisions of the liquid crystal element to change the refractive index of the divisions; and

a control section for controlling the operation of the voltage applying section which applies a voltage to the divisions of the liquid crystal element to adjust the amount of phase compensation imparted to light incident on each of the divisions of the liquid crystal element such that a spot formed by light transmitted by the liquid crystal element undergoes a phase change that is uniform in the spot.

According to the invention, the liquid crystal element is provided on an optical path of diffuse light between the light source and the objective lens, and is divided to have a plurality of divisions. The voltage applying section applies a voltage to the plurality of divisions of the liquid crystal element to change the refractive index of the divisions. The control section controls the operation of the voltage applying section for applying a voltage to the divisions of the liquid crystal element to adjust the amount of phase compensation imparted to light incident on each of the divisions of the liquid crystal element such that a spot formed by light transmitted by the liquid crystal element undergoes a phase change that is uniform in the spot. It is therefore possible to reduce a difference between amounts of phase changes in a light spot attributable to the angle of incidence of light entering the liquid crystal element, and recording and reproduction characteristics of an optical recording medium can be improved.

In the invention, it is preferable that the optical head further comprises a diffusing angle adjusting element for adjusting the diffusing angle of light incident thereon, and the diffusing angle adjusting element is disposed between the light source and the objective lens.

According to the invention, the optical head further comprises the diffusing angle adjusting element for adjusting the diffusing angle of light incident thereon, and the diffusing angle adjusting element which may be a coupling lens can be used in the optical head. It is therefore possible to make the optical head compact and to improve coupling efficiency. Further, since the liquid crystal element and the control section as described above are provided, the amount of a phase change can be made uniform in the spot of the light incident on the liquid crystal element, and recording and reproduction can therefore be performed satisfactorily.

In the invention, it is preferable that the liquid crystal element is disposed between the diffusing angle adjusting element and the objective lens.

According to the invention, even if the light incident on the liquid crystal element becomes diffuse light as a result of the insertion of the liquid crystal element between the diffusing angle adjusting element and the objective lens, a difference in the amount of phase change in a spot of light incident on the liquid crystal display can be reduced.

In the invention, it is preferable that the liquid crystal element is disposed between the diffusing angle adjusting element and the light source.

According to the invention, a difference in the amount of phase change can be reduced in a spot formed by light even when the light is diffuse light which has been transmitted by a diffusing angle adjusting element and which has a great difference in the angle of incidence between the neighborhoods of the periphery and the center of the light spot. It is therefore possible to improve the recording and reproduction characteristics of an optical recording medium further.

In the invention, it is preferable that the liquid crystal element and the diffusing angle adjusting element are provided integrally with each other.

According to the invention, since the liquid crystal element and the diffusing angle adjusting element are provided integrally with each other, the optical head can be made compact.

In the invention, it is preferable that the diffusing angle adjusting element is a Fresnel lens.

According to the invention, since the diffusing angle adjusting element is a Fresnel lens, the size of the optical head can be further reduced.

In the invention, it is preferable that the liquid crystal element includes a transparent electrode in each of the divisions.

According to the invention, since the transparent electrode provided in each division is used as an electrode for applying a voltage to the liquid crystal element, there is no reduction in the intensity of light attributable to the electrode which otherwise blocks light.

In the invention, it is preferable that the direction in which the plurality of divisions of the liquid crystal element are arranged is in parallel with a radial direction of an optical recording medium in a recording or reproducing state.

According to the invention, the direction in which the plurality of divisions of the liquid crystal element are arranged is in parallel with the radial direction of an optical recording medium in a recording or reproducing state. An information reproduction signal is not included in peripheral parts of a spot of light incident on the liquid crystal element in the radial direction of the light spot. Therefore, the angle of incidence at critical areas between a part including the information reproduction signal and the parts including no information reproduction signal in the radial direction of the light spot is smaller than the angle of incidence at peripheral parts of the light spot in a track direction that is perpendicular to the radial direction. Thus, variation in the amount of phase compensation imparted to cause a uniform phase change in the light spot will be smaller when the phase change is imparted in the radial direction than when the phase change is imparted in the track direction. For this reason, it is preferable to impart a phase change in the radial direction and variation in the amount of phase compensation imparted in the light spot can be reduced to allow a uniform phase change in the light spot more easily by arranging the divisions of the liquid crystal element in a direction in parallel with the radial direction of the optical recording medium.

In the invention, it is preferable that the light source emits laser light having a wavelength of 780 nm, and the objective lens has a numerical aperture NA of According to the invention, a light source emitting laser light having a wavelength of 780 nm and an objective lens having a numerical aperture (NA) of 0.45 is used when an MD or Hi-MD is used as the optical recording medium, which makes it possible to obtain a satisfactory recording/reproduction signal from either MD or Hi-MD.

The invention further provides a disk reproducing apparatus comprising the optical head mentioned above.

According to the invention, since the apparatus includes the optical head mentioned above, a difference in the amount of phase change in a light spot attributable to the angle of incident of the light can be reduced to improve recording and reproduction characteristics of an optical recording medium, which also allows the disk reproducing apparatus to perform recording and reproduction satisfactorily.

### BRIEF DESCRIPTION OF THE DRAWINGS

Other and further objects, features, and advantages of the invention will be more explicit from the following detailed description taken with reference to the drawings wherein:

FIG. 1 is a sectional view showing a schematic configuration of an optical head according to a first embodiment of the invention;

FIG. 2 is a schematic plan view showing a condition where an information recording surface of an optical recording medium is irradiated with a light spot;

FIG. 3 is a plan view showing a configuration of the liquid crystal element;

FIG. 4 is a plan view showing a configuration of a photodetector;

FIGS. 5A and 5B are sectional views schematically showing conditions where diffuse light enters the liquid crystal element;

FIG. 6 is a view showing amounts of phase changes at various positions in a radial direction of a light spot formed by diffuse light incident on an undivided liquid crystal element measured when an amount of phase compensation that is optimal in the center of the optical axis of the light is uniformly imparted to the entire incident light;

FIG. 7 is a view showing amounts of phase compensation imparted to incident light that is diffuse light by the liquid crystal element having the plurality of divisions shown in FIG. 3;

FIG. 8 is a view showing an amount of phase change in each division measured when a different amount of phase compensation is imparted to diffuse light incident on the liquid crystal element having a plurality of divisions;

FIG. 9 is a view showing error rates at the time of reproduction of the optical recording medium performed with phase compensation imparted by the liquid crystal element which is not divided into a plurality of parts and error rates at the time of reproduction of the optical recording medium performed with phase compensation imparted by the liquid crystal element having a plurality of divisions;

FIG. 10 is a sectional view showing a schematic configuration of an optical head according to a second embodiment of the invention;

FIG. 11 is a sectional view showing a schematic configuration of an optical head according to a third embodiment of the invention;

FIG. 12 is a sectional view showing a schematic configuration of an optical head according to a fourth embodiment of the invention; and

FIG. 13 is a sectional view showing a schematic configuration of a related-art optical head.

### DETAILED DESCRIPTION

Now referring to the drawings, preferred embodiments of the invention are described below.

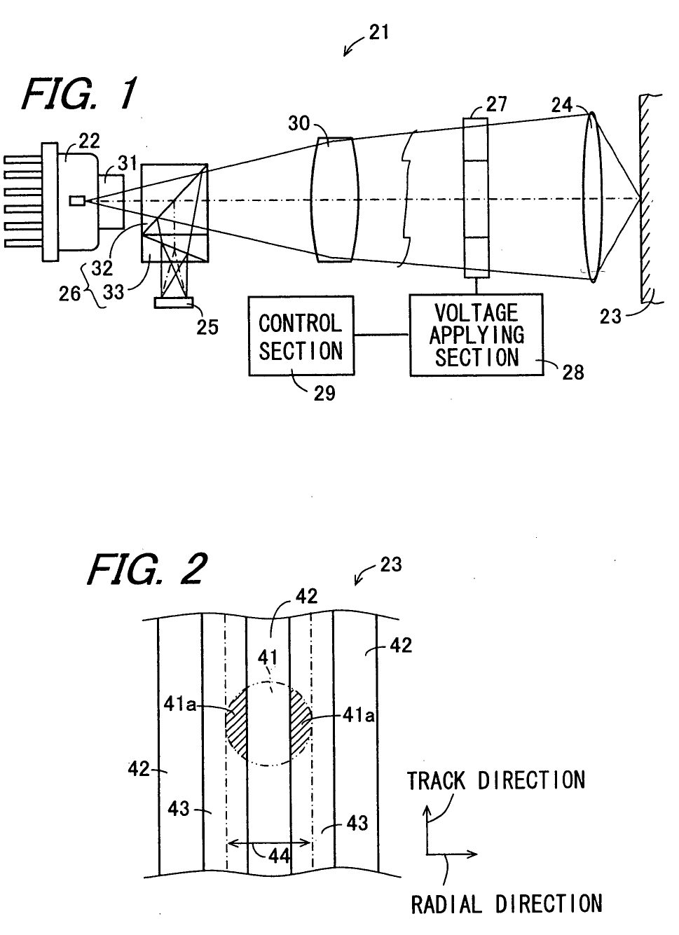

FIG. 1 is a sectional view showing a schematic configuration of an optical head 21 according to a first embodiment of the invention. The optical head 21 comprises a semiconductor laser element 22, an objective lens 24, a photodetector 25, an optical system 26, a liquid crystal element 27, a voltage applying section 28 and a control section 29. The semiconductor laser element 22 is a light source emitting light. The objective lens 24 converges the light emitted by the semiconductor laser element 22 on an optical recording medium 23. The photodetector 25 receives light reflected by the optical recording medium 23 and converting the received light into an electrical signal. The optical system 26 guides the light emitted by the semiconductor laser element 22 to the objective lens 24 and guiding the light reflected by the optical recording medium 23 to the photodetector 25. The liquid crystal element 27 is provided on an optical path of diffuse light between the semiconductor laser element 22 and the objective lens 24 and which is divided to have a plurality of divisions. The voltage applying section 28 applies a voltage to the liquid crystal element 27. The control section 29 controls the operation of the voltage applying section 28 for applying a voltage to the divisions of the liquid crystal element 27 to adjust the amount of phase compensation imparted to light incident on each of the divisions of the liquid crystal element 27 such that a spot formed by light transmitted by the liquid crystal element 27 undergoes a phase change that is uniform in the spot.

In the context of the invention, the term “the amount of phase compensation” means the amount of a phase change that is imparted to light incident thereon by the liquid crystal element, and the term “the amount of phase change” means the amount of a phase change of light as a result of the application of the phase compensation by the liquid crystal element.

The optical head 21 includes a coupling lens 30 which is a diffusing angle adjusting element for adjusting the diffusing angle of light incident thereon. The coupling lens 30 is disposed between the objective lens 24 and the optical system 26. The liquid crystal element 27 is disposed between the coupling lens 30 and the objective lens 24.

The semiconductor laser element 22 emits laser light having a wavelength of 780 nm, for example, when the optical recording medium 23 is a magneto-optical recording medium such as an MD or Hi-MD. The semiconductor laser element 22 is connected to an external circuit (not shown) for supplying a drive current, and the intensity of the laser light can be changed by changing the amount of the current from the external circuit. The light emitted by the semiconductor laser element 22 enters a grating 31.

The grating 31 is a diffraction grating for separating the light emitted by the semiconductor laser element 22 into zero-order diffracted light, −first-order diffracted light and +first-order diffracted light. The laser light transmitted by the grating 31 is guided by the optical system 26 to the objective lens 24.

The optical system 26 includes a polarization beam splitter 32 which transmits or reflects light incident thereon and a Wollaston prism 33 which separates light incident thereon into a plurality of beams. The polarization beam splitter 32 transmits outgoing light emitted by the semiconductor laser element 22 to guide the outgoing light to the objective lens 24 and reflects return light reflected by the optical recording medium 23 to guide the return light to the photodetector 25. The Wollaston prism 33 separates the light entering itself after being reflected by the optical recording medium 23 and the polarization beam splitter 32 into a plurality of beams and projects the plurality of beams thus separated on the photodetector 25.

The coupling lens 30 exits the light entering after being emitted by the semiconductor laser element 22 and transmitted by the grating 31 and the polarization beam splitter 32, for example, in a state of decreasing the diffusing angle thereof. The light transmitted by the coupling lens 30 enters the liquid crystal element 27. The use of such a coupling lens 30 makes it possible to reduce the size of the optical head 21 in the direction of the optical axis of light exiting the same and in the direction of the focus of the objective lens 24 and to improve the intensity of the light exiting the objective lens 24.

FIG. 2 is a schematic plan view showing a condition where an information recording surface of the optical recording medium 23 is irradiated with a light spot 41. Grooves 42 in the form of guide grooves for recoding an information recording/reproduction signal is provided on the information recording surface of the optical recording medium 23. When information recorded on the optical recording medium 23 is to be reproduced, the optical head 21 irradiates the interior of a groove 42 with a light spot 41 formed by the laser light emitted by the semiconductor laser element 22 and reads the information recorded in the groove 42 from a reflection of the irradiating laser light.

The optical recording medium 23 has a track pitch 44 of 1.6 μm when it is an MD, and the track pitch 44 is 1.25 μm when the medium is a Hi-MD which can achieve recording in a high density. When information is recorded or reproduced on or from the optical recording medium 23 with the optical head 21, a light spot formed by laser light emitted by the semiconductor laser element 22 to irradiate the optical recording medium 23 has a diameter of, for example, 1.6 μm, and the light spot 41 extends beyond a groove 42 in such a case. Regions 41a of the light spot extending beyond the groove 42 as thus described are reflected on the surface of lands 43, which are adjacent to the groove 42 irradiated with the light, and are included in light reflected by the groove 42. Such a phenomenon is referred to as crosstalk. When the light reflected by the groove 42 includes another beam of light, many errors can be generated in an electrical signal, e.g., an information recording/reproduction signal (RF signal) obtained by converting the light with the photodetector 25 which has received the light, whereby recording and reproduction characteristics can be degraded.

The liquid crystal element 27 provided in the optical head 21 of the present embodiment is disposed on the optical path of such light reflected from the optical recording medium 23. The element imparts a phase change to the reflected light to reduce errors by limiting crosstalk components from the lands 43, thereby preventing degradation of recording and reproduction characteristics.

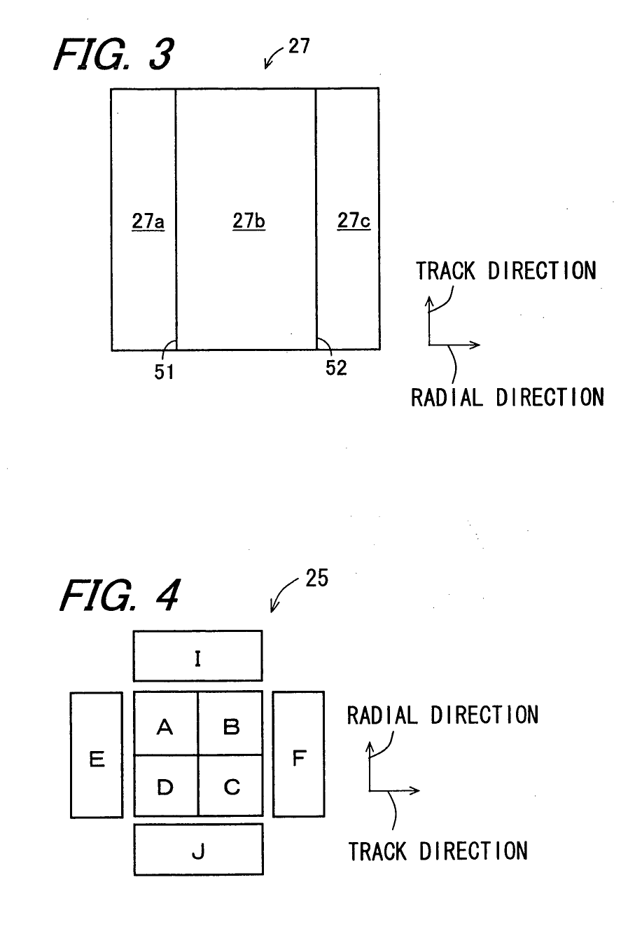

FIG. 3 is a plan view showing a configuration of the liquid crystal element 27. The liquid crystal element 27 provided in the optical head 21 of the present embodiment is divided by division lines 51 and 52 extending in a direction tangential to tracks formed on the optical recording medium 23 in a recording or reproducing state (the direction will be hereinafter referred to as a track direction) into a plurality of (three in the present embodiment) divisions 27a, 27b, and 27c. The direction in which the plurality of divisions 27a, 27b, and 27c are arranged is in parallel with a radial direction of the optical recording medium 23 in a recording or reproducing state.

In each of the divisions 27a, 27b, and 27c of the liquid crystal element 27, there is provided a pair of transparent electrodes, i.e., a transparent electrode connected to the voltage applying section 28 and another transparent electrode disposed opposite to the transparent electrode connected to the voltage applying section 28, and a liquid crystal layer disposed between the pair of transparent electrodes. Such liquid crystal layers and transparent electrodes are confined between glass substrates.

A voltage is applied from the voltage applying section 28 to the liquid crystal element 27 through the transparent electrodes provided in the divisions 27a, 27b, and 27c. When the liquid crystal element 27 is divided into a plurality of divisions each of which has transparent electrodes as thus described, the voltage applying section 28 can apply a different voltage to each of the divisions 27a, 27b, and 27c. The use of transparent electrodes as the electrodes provided in the plurality of divisions of the liquid crystal element 27 prevents any reduction in the intensity of light attributable to the electrodes which otherwise block the light. The refractive index of the liquid crystal element 27 is changed by applying a voltage to the pair of transparent electrodes, whereby a phase change is imparted to light incident on the same.

The liquid crystal element 27 has a problem in that its characteristics such as optical characteristics are changed by a temperature change. In the optical head 21 of the present embodiment, a temperature sensor (not shown) for measuring the temperature on the surface of the liquid crystal element 27 is provided in the vicinity of the liquid crystal element 27, and changes in the characteristics attributable to a temperature change are corrected using data on a table which is incorporated in advance in an LSI (Large Scale Integration) and on which temperatures and voltages are associated with each other.

The liquid crystal element 27 applied with a voltage from the voltage applying section 28 imparts a phase change to light incident thereon to polarize the incident light into substantially linearly polarized light. The voltage applying section which applies a voltage to each of the transparent electrodes of the divided liquid crystal element 27 includes a power supply (not shown) and a modulator which carries out a pulse width modulation (PWM). The operation of the voltage applying section 28 is controlled by the control section 29.

The control section 29 controls the operation of the voltage applying section 28 which applies a voltage to the divisions 27a, 27b, and 27c of the liquid crystal element 27 to adjust the amount of phase compensation imparted to light incident on each of the divisions 27a, 27b, and 27c of the liquid crystal element 27 such that a spot formed by light transmitted by the liquid crystal element 27 undergoes a phase change that is uniform within the spot. A description will be made later on causes of a difference in the amount of phase change in a light spot formed by diffuse light incident on the liquid crystal element 27 and a method of adjusting the amount of phase compensation to reduce the difference in the amount of phase change.

The control section 29 controls the operation of the voltage applying section 28 not only to reduce a difference in the amount of phase change in a light spot but also to adjust the amount of phase compensation for the liquid crystal element 27 depending on the type of the optical recording medium 23. The control section 29 detects the type of the optical recording medium 23 and controls the operation of the voltage applying section 28 to apply a voltage having a value according to the type of the optical recording medium 23, the value being obtained through a test, for example, and stored in a memory included in the control section 29 in advance.

The control section 29 determines the type of the optical recording medium 23 based on, for example, TOC (Table Of Contents) information recorded in advance in the optical recording medium 23, an electrical signal obtained by the photodetector 25, or the like.

For example, when the optical recording medium 23 is a magneto-optical recording medium such as an MD or Hi-MD, an objective lens 24 having a numerical aperture (NA) of 0.45 is used. The objective lens 24 is mounted on an actuator (not shown) for holding the objective lens 24 such that the lens can be moved in a focus direction that is the direction of the optical axis of light incident thereon and in a track direction that is a direction orthogonal to the radial direction of the optical recording medium 23. The objective lens converges outgoing light emitted by the semiconductor laser element 22 on the information recording surface of the optical recording medium 23 to form a light spot on the information recording surface. The light converged on the information recording surface is subjected to a phase change imparted by the liquid crystal element 27, transmitted by the coupling lens 30, and reflected by the polarization beam splitter 32 to enter the Wollaston prism 33.

For example, the Wollaston prism 33 separates the light incident thereon into a main signal which is used for s servo system for detecting an FE signal and a TE signal and a I-signal and a J-signal which are used as MO (Magneto-Optical) signals (RF signals) and projects the signals on respective light-receiving regions of the photodetector 25.

The photodetector 25 is a signal conversion section for converting laser light incident thereon into an electrical signal and performing calculations on the signal to output an FE signal, a TE signal, and an RF signal. The photodetector 25 is provided with a plurality of light-receiving regions.

FIG. 4 is a plan view showing a configuration of the photodetector 25. For example, the photodetector 25 includes light-receiving regions A, B, C, and D, two rectangular light-receiving regions E and F, and two rectangular light-receiving regions I and J. The light-receiving regions A, B, C, and D are four rectangular divisional light-receiving regions having equal areas disposed in the form of a matrix of two rows and two columns. The two rectangular light-receiving regions E and F are disposed in the track direction on both sides of the light-receiving regions A to D. The two rectangular light-receiving regions I and J are disposed in the radial direction on both sides of the light-receiving regions A to D. The light-receiving regions A to D receive light which is zero-order light separated by the grating 31 and which is used for the main signal separated by the Wollaston prism 33 and output an FE signal. The light-receiving regions E and F receive −first-order diffracted light and +first-order diffracted light separated by the grating 31 which are used for the main signal separated by the Wollaston prism 33 to detect a TE signal. The light-receiving regions I and J receive beams of light which are zero-order refracted light separated by the grating 31 and which are used for the I- and J-signals separated by the Wollaston prism 33 to detect an RF signal.

The photodetector 25 receives incident beams of light in the light-receiving regions A to J and outputs electrical signals as shown in the following expressions. In the following expressions, the value represented by the signal detected at each of the light-receiving regions is indicated by “S” preceding the alphabet representing the light-receiving region.
FE signal=(SA+SC)−(SB+SD)
TE signal=SE−SF
RF signal=SI−SJ

A description will now be made on causes of a difference in the amount of phase change in a light spot formed by diffuse light incident on the liquid crystal element 27 and a method of adjusting the amount of phase compensation performed to reduce the difference in the amount of phase change with the liquid crystal element 27, such an adjustment being most characteristic of the invention.

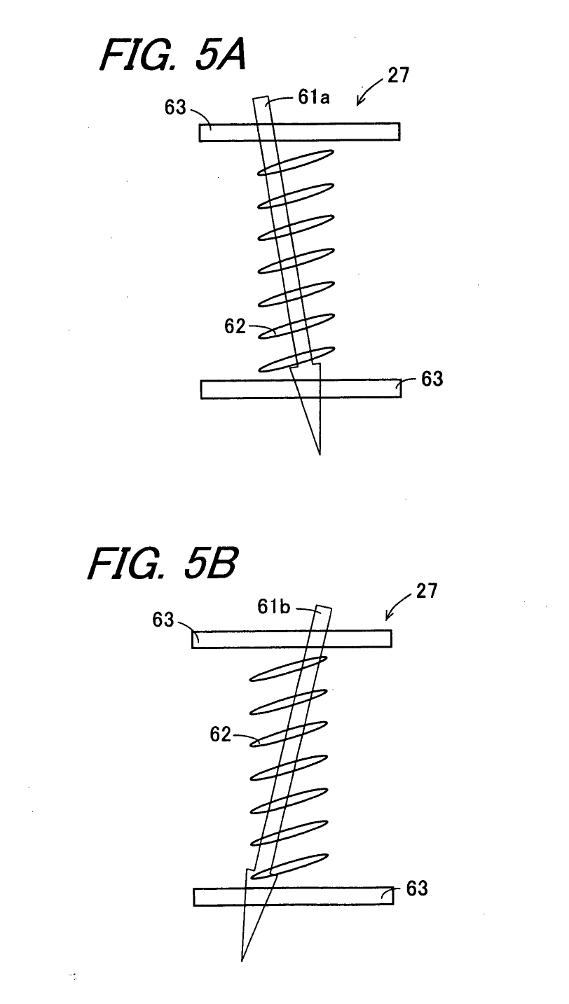

FIGS. 5A and 5B are sectional views schematically showing conditions where diffuse light enters the liquid crystal element 27. FIG. 5A schematically shows a condition where a beam 61a of light enters the liquid crystal element 27 at a peripheral part of the spot of the incident light that is diffuse light. FIG. 5B shows a condition where a beam 61b of light enters the liquid crystal element 27 at a peripheral part of the spot of the incident light opposite to the part shown in FIG. 5A.

The liquid crystal element 27 has a pair of transparent electrodes (not shown) and a liquid crystal layer (not shown) disposed between the pair of transparent electrodes. A liquid crystal 62 forming the liquid crystal layer and the pair of transparent electrodes are confined between glass substrates 63. The liquid crystal element 27 applied with a voltage from the voltage applying section 28 imparts a phase change to light incident thereon and polarizes the incident light into substantially linearly polarized light.

When light enters such a liquid crystal element 27, the refractive index of the liquid crystal 62 against the incident light changes depending on the angle of incidence of the incident light. When the angle of incidence changes, the amount of a phase change will be different from a desired value even if the voltage applied to the liquid crystal element 27 is kept unchanged to impart a phase change to the incident light in the same amount as that prior to the change in the angle of incidence.

In such a difference in the amount of phase change attributable to a change in the refractive index, a problem arises not only between a plurality of beams of light having different angles of incidence, but also, in a case where the incident light is diffuse light, between a beam of light in the vicinity of one peripheral part of the light spot and a beam of light in the vicinity of another peripheral part which is located opposite to the beam of light in one peripheral part with respect to the optical axis of the incident light. A difference between the refractive index of the liquid crystal in the vicinity of the center of the light spot and the refractive index of the liquid crystal in the vicinity of a peripheral part of the light spot results in a difference between the amount of a phase change in the vicinity of the center of the light spot and the amount of a phase change in the vicinity of the peripheral part of the light spot.

The difference between the amount of a phase change at the center of the light spot and the amount of a phase change at the peripheral part of the light spot is expressed by Expression (1) shown below where the term “refractive-index difference” means a difference between the refractive index at the center of the light spot and the refractive index at the peripheral part of the light spot.
(difference in the amount of phase change)=(refractive-index difference)×(liquid crystal thickness)×360/(wavelength of the incident light) (1)

As apparent from Expression (1), when there is a difference in the amount of phase change in the same light spot, even when an optimum amount of phase compensation is imparted to the incident light that is diffuse light in the vicinity of the center of the light spot, the amount of a phase change at a peripheral part of the light spot will be different from an optimum value.

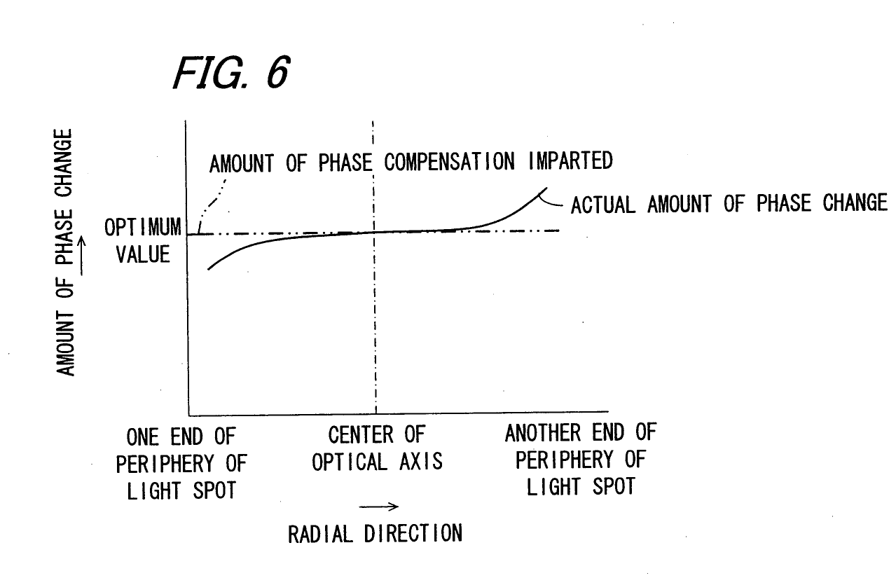

FIG. 6 shows amounts of phase changes at various positions in the radial direction of a light spot formed by diffuse light incident on an undivided liquid crystal element measured when an amount of phase compensation that is optimal in the center of the optical axis of the light is uniformly imparted to the entire incident light. The liquid crystal element imparts the amount of phase compensation that is optimal at the center of the incident light which is diffuse light (the center of the light spot) to the entire light spot. As a result, the incident light can be substantially linearly polarized in the vicinity of the center of the light spot formed by the incident light.

However, as described above, the amount of a phase change at a peripheral part of the light spot of the incident light that is diffuse light deviates from an optimum value because the angle of incidence of the incident light is different from that at the center of the optical axis even if the optimum amount of phase compensation same as that in the center of the light spot is imparted in such a part. When the amount of a phase change deviates from an optimum value as thus described, the state of polarization of the light at the peripheral part of the light spot transfers from linear polarization to elliptic polarization.

In order to reduce such a difference in the amount of phase change in a light spot caused by a difference in refractivity attributable to a difference in the angle of incidence of light, the optical head 21 of the present embodiment employs the liquid crystal element 27 which is divided into a plurality of divisions 27a, 27b, and 27c as shown in FIG. 3. The liquid crystal element 27 having the divisions 27a, 27b, and 27c as shown in FIG. 3 can set a different refractive index for light incident on each of the divisions 27a, 27b, and 27c by applying different voltages to the transparent electrodes provided in the divisions 27a, 27b, and 27c, respectively. Thus, a different amount of phase compensation can be imparted to light incident on each of the divisions 27a, 27b, and 27c.

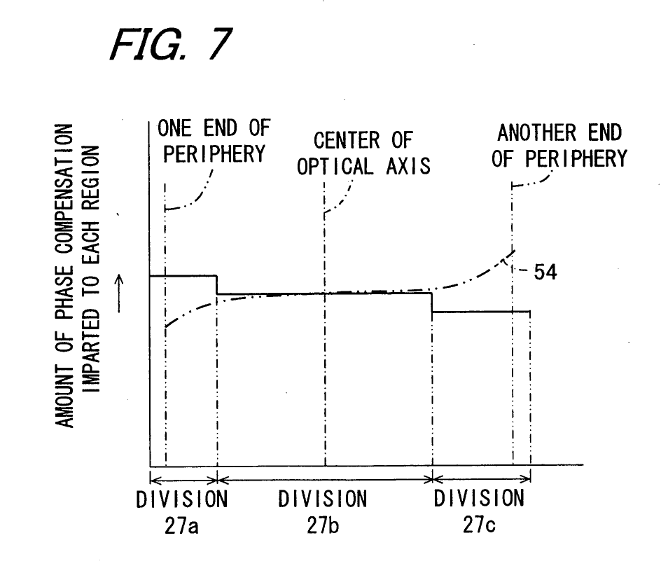

FIG. 7 shows amounts of phase compensation imparted to incident light that is diffuse light by the liquid crystal element 27 having the plurality of divisions shown in FIG. 3. In FIG. 7, the solid line represents the amounts of phase compensation imparted to incident light in the divisions 27a, 27b, and 27c. In FIG. 7, the line 54 in a chain double-dashed line represents amounts of phase changes that occur when an amount of phase compensation is uniformly imparted to a light spot of diffuse light incident on the above-described liquid crystal element which is not divided into a plurality of parts.

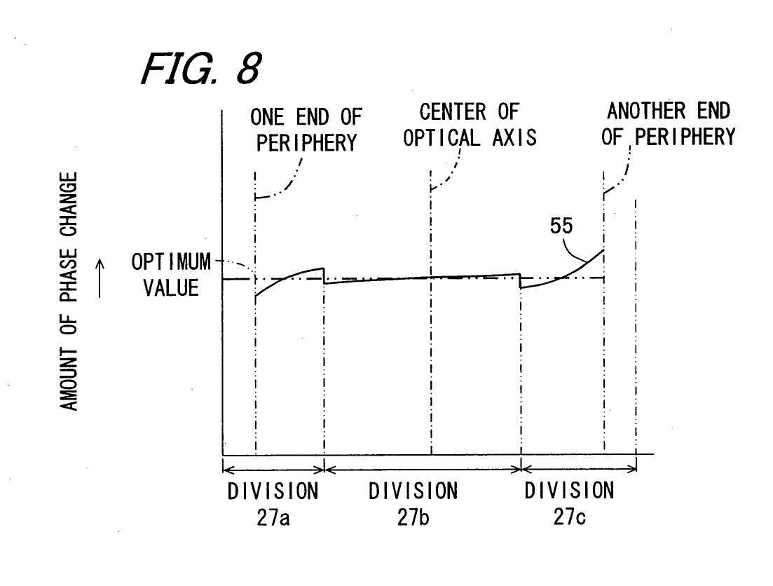

In the division 27a, an amount of phase compensation greater than the amount of phase compensation in the vicinity of the center of the light spot is imparted to an end of the periphery of the light spot where the actual amount of a phase change is smaller than an optimum value. In the division 27b, no change is made in the amount of phase compensation because the difference between the actual amount of phase change and the optimum amount of phase change is small. In the division 27c, an amount of phase compensation smaller than the amount of phase compensation in the vicinity of the center of the light spot is imparted to another end of the periphery of the light spot where the actual amount of phase change is greater than the optimum value. Namely, as shown in FIG. 8 mentioned below, in the divisions 27a and 27c on both sides of the division 27b, an amount of phase compensation is provided so that an average of the amounts of phase compensation in the divisions 27a and 27b is substantially equal to an optimum amount of phase compensation.

In order to vary the amount of phase compensation between the divisions 27a, 27b, and 27c of the liquid crystal element 27 as thus described, the voltages applied to the transparent electrodes provided in the divisions 27a, 27b, and 27c may have values which are, for example, obtained through a test and stored in a memory provided in the control section 29 in advance.

FIG. 8 shows an amount 55 of phase change in each division measured when a different amount of phase compensation is imparted to diffuse light incident on the liquid crystal element 27 having a plurality of divisions. The liquid crystal element 27 is divided into a plurality of parts, and the amount of phase compensation is varied by applying different voltages from the voltage applying section 28 to the neighborhood of the center of the light spot and the neighborhoods of peripheral parts of the spot. As a result, differences in the amount of phase change in the light spot from an optimum value can be made small, and differences between the amounts of phase change in the light spot can be made small.

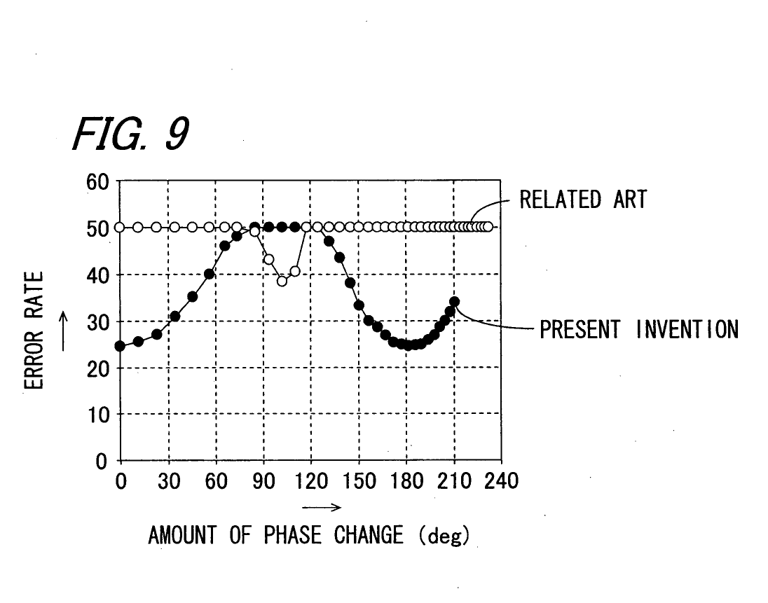

FIG. 9 shows error rates at the time of reproduction of the optical recording medium 23 performed with phase compensation imparted by the liquid crystal element which is not divided into a plurality of parts and error rates at the time of reproduction of the optical recording medium 23 performed with phase compensation imparted by the liquid crystal element 27 having a plurality of divisions. White circles represent the error rates in a case where phase compensation is imparted by the liquid crystal element which is not divided into a plurality of parts (shown as “RELATED ART” in FIG. 9), and black circles represent the error rates in a case where phase compensation is imparted by the liquid crystal element 27 having a plurality of divisions provided in the optical head 21 according to the invention (shown as “PRESENT INVENTION” in FIG. 9). The amounts of phase compensation shown along a horizontal axis in the case of the liquid crystal element 27 having a plurality of divisions are amounts of phase compensation imparted in the division 27b. The term “error rate” means a measured number of errors which have occurred in a unit time. The error rates were measured using an MD as the optical recording medium 23.

As shown in FIG. 9, the error rates measured when phase changes are imparted by the liquid crystal element 27 having a plurality of divisions are significantly smaller than the error rates measured when phase changes are imparted by the liquid crystal element which is not divided into a plurality of parts with respect to most amounts of phase compensation except in a certain range (from about 90° to 120°). As thus described, a liquid crystal element may be divided into a plurality of parts to allow voltages applied to the neighborhood of the center of a light spot and the neighborhood of peripheral parts of the spot to be appropriately chosen. It will be understood that the amount of phase compensation can be varied between the divisions to reduce a difference in the amount of phase change within the light spot and that recording and reproduction characteristics of an optical recording medium can be improved.

The liquid crystal element 27 preferably imparts a phase change such that the polarization axis of light adjusted to linear polarization will be in parallel with the radial direction of the optical recording medium 23 in a recording or reproducing state. The reason is as described below.

As shown in FIG. 2, the liquid crystal element 27 is used to limit crosstalk components attributable to light reflected on the surface of the lands 43 adjacent to the groove 42. When an information recording/reproduction signal in the groove 42 is obtained, the information recording/reproduction signal recorded in the groove 42 is included up to the peripheral parts of the light spot 41 in the track direction of the light spot 41. When the information recording/reproduction signal is viewed in the radial direction of the light spot 41, the signal is not included in the regions 41a of the light spot located around the periphery of the light spot 41 because the regions are irradiated by light from the lands 43. That is, the information recording/reproduction signal exists only in the neighborhood of the center of the light spot 41 in the radial direction of the light spot 41.

Since a reflected light can be regarded as a wave, a phase will now be discussed on an assumption that the reflected light may be divided into a P-wave that is a wave in the radial direction and an S-wave that is a wave in the track direction. When the optical recording medium 23 is an MD, the P-wave and S-wave of light reflected by the optical recording medium 23 are substantially in phase (S−P=0°). When the optical recording medium 23 is a Hi-MD, however, the P-wave of light reflected by the optical recording medium 23 is delayed from the S-wave by δ° (S−P=δ°) If an equation δ=0 becomes true as a result of the use of the liquid crystal element 27, optimum recording and reproduction characteristics can be achieved even when the optical recording medium 23 is a Hi-MD. There are two methods of making the equation δ=0 true. One method is to delay the S-wave that is a wave in the track direction by δ°, and the other method is to advance the P-wave that is a wave in the radial direction by δ° or to delay the P-wave that is a wave in the radial direction by 2π−δ°.

As described above, the information recording/reproduction signal recorded in the groove 42 is included the light spot 41 up to the peripheral parts thereof in the track direction of the light spot 41. Therefore, according to the method in which the S-wave that is a wave in the track direction is delayed by δ°, a phase change must be imparted to beams of light at the peripheral parts of the light incident on the liquid crystal element 27. As a result, a slight difference in the amount of phase change occurs in the light spot even if the liquid crystal element 27 provided in the optical head 21 of the present embodiment is used.

An information reproduction signal recorded in the groove 42 is not included in the light spot 41 at the peripheral parts thereof in the radial direction of the light spot 41. Therefore, according to the method in which the P-wave that is a wave in the radial direction is advanced by δ°, the information reproduction signal is not included in the peripheral parts of the light incident on the liquid crystal element 27. As a result, even if there is a slight difference in the mount of phase change in the light spot, the angle of incidence at critical areas between the part including the information reproduction signal and the parts including no information reproduction signal is smaller than the angle of incidence at the peripheral parts of the light spot in the radial direction thereof. Therefore, the resultant information reproduction signal includes substantially no difference in the amount of phase change.

In summary, the angle of incidence at the critical areas between the part including the information reproduction signal and the parts including no information reproduction signal in the radial direction of the light spot is smaller than the angle of incidence at the peripheral parts of the spot in the track direction perpendicular to the radial direction. Therefore, variation in the amount of phase compensation imparted to cause a uniform phase change in the light spot will be smaller when the phase change is imparted in the radial direction than when the phase change is imparted in the track direction. For this reason, it is preferable to impart a phase change in the radial direction of the optical recording medium 23, and variation in the amount of phase compensation imparted in the light spot can be reduced to allow a uniform phase change in the light spot more easily by arranging the divisions 27a, 27b, and 27c of the liquid crystal element 27 in a direction in parallel with the radial direction of the optical recording medium 23.

The operation of the optical head 21 will now be described. Laser light emitted by the semiconductor laser element 22 passes through the grating 31 to be separated into zero-order diffracted light, +first-order diffracted light, and −first-order diffracted light which are then transmitted by the polarization beam splitter 32. The laser light transmitted by the polarization beam splitter 32 passes through the coupling lens 30 at which the diffusing angle of the light is changed. The light is thereafter transmitted by the liquid crystal element 27 and converged on the information recording surface of the optical recording medium 23. The light converged on the optical recording medium 23 is reflected by the optical recording medium 23 and transmitted by the objective lens 24 to enter the liquid crystal element 27.

When the light enters the liquid crystal element 27, a voltage which is determined according to the type of the optical recording medium 23 is applied to the transparent electrodes of the liquid crystal element 27 by the voltage applying section 28 to adjust the amount of phase compensation. Since the liquid crystal element 27 has a plurality of transparent electrodes as shown in FIG. 3, a difference in the amount of phase change in the light spot attributable to the angle of incidence of the light can be reduced.

The laser light to which a phase change has been imparted by the liquid crystal element 27 is transmitted by the coupling lens 30, reflected by the polarization beam splitter 32, and separated by the Wollaston prism 33, and received in predetermined positions of the photodetector 25. The photodetector 25 outputs electrical signals, i.e., the FE signal, the TE signal, and the RF signal using the received laser light.

As described above, in the optical head 21 of the present embodiment, since the liquid crystal element 27 is divided into a plurality of regions 27a, 27b, and 27c, the value of the voltage applied to the liquid crystal element 27 can be appropriately selected depending on the position in a light spot, i.e., the neighborhood of the center of the spot or the neighborhood of the periphery thereof to adjust the amount of phase compensation imparted to the incident light. It is therefore possible to reduce a difference in the amount of phase change in the light spot and to thereby improve recording and reproduction characteristics of the optical recording medium 23.

The optical recording medium 23 recorded and reproduced by the optical head 21 is not limited to magneto-optical recording media such as MDs or Hi-MDs, and optical recording media such as CDs (Compact Disc) DVDs (Digital Versatile Disks) and Blu-ray disks; registered trademark) may be used.

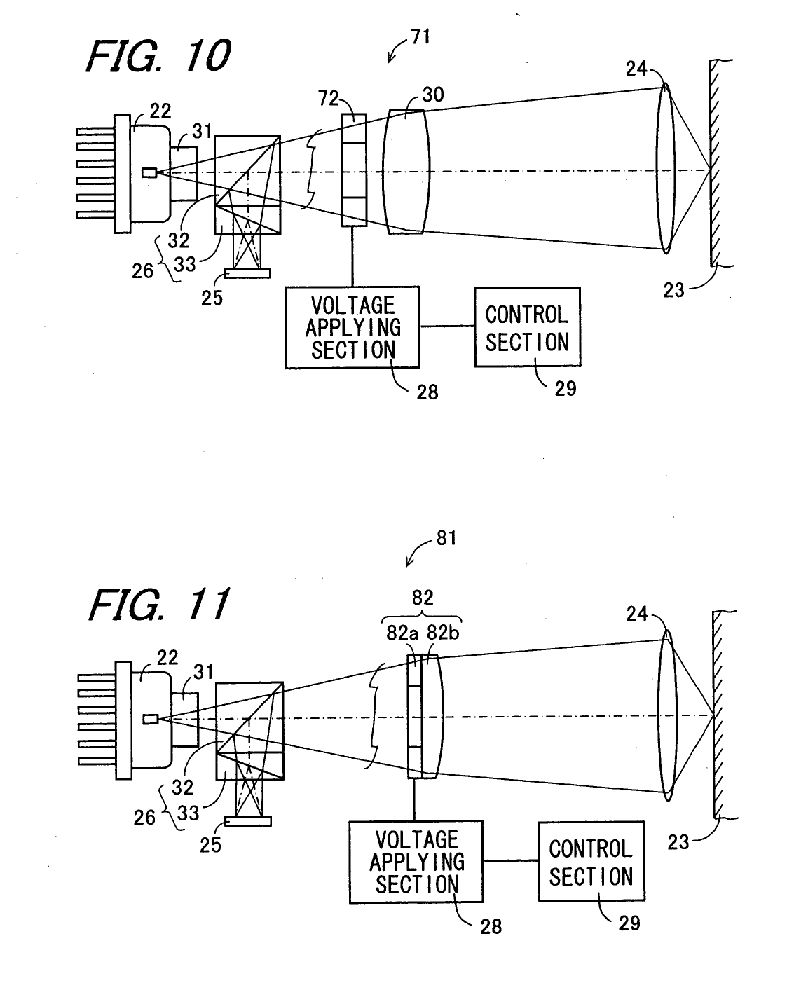

FIG. 10 is a sectional view showing a schematic configuration of an optical head 71 according to a second embodiment of the invention. The optical head 71 according to the present embodiment is similar to the optical head 21 according to the first embodiment, so that the corresponding components will be denoted by the same reference numerals, and descriptions thereof will be omitted. In the optical head 71 according to the second embodiment, a liquid crystal element 72 is disposed between the coupling lens 30 and a semiconductor laser element 22 that is the light source, more concretely between the coupling lens 30 and the optical system 26.

Referring to the liquid crystal element 72, an element having a plurality of divisions similar to the liquid crystal element 27 is used. Therefore, the optical head 71 of the present embodiment can reduce a difference in the amount of phase change in a spot formed by light even when the light is diffuse light which has been transmitted by the coupling lens 30 serving as a diffusing angle adjusting element and which has a great difference in the angle of incidence between the neighborhoods of the periphery and the center of the light spot. It is therefore possible to improve the recording and reproduction characteristics of an optical recording medium 23 further.

FIG. 11 is a sectional view showing a schematic configuration of an optical head 81 according to a third embodiment of the invention. The optical head 81 according to the present embodiment is similar to the optical head 71 according to the second embodiment, so that the corresponding components will be denoted by the same reference numerals, and descriptions thereof will be omitted. In the optical head 81 according to the third embodiment, a liquid crystal element 82a and a coupling lens 82b are provided integrally with each other to constitute a phase compensation imparting section 82. The liquid crystal element 82a is disposed between the coupling lens 82b and the semiconductor laser element 22 that is the light source, more concretely between the coupling lens 82b and the optical system 26.

Referring to the liquid crystal element 82a included in the phase compensation imparting section 82, an element having a plurality of divisions similar to the liquid crystal element 27 may be used to reduce any difference in the mount of phase change in a light spot. The coupling lens 82b serving as a diffusing angle adjusting element included in the phase compensation imparting section 82 is a lens which adjusts the diffusing angle of incident light similarly to the coupling lens 30 used in the optical head 21 of the first embodiment.

In accordance with the optical head 81 according to the present embodiment, since the phase compensation imparting section 82 provided by integrating the liquid crystal element 82a and the coupling lens 82b is used, it is possible to make the optical head 81 compact.

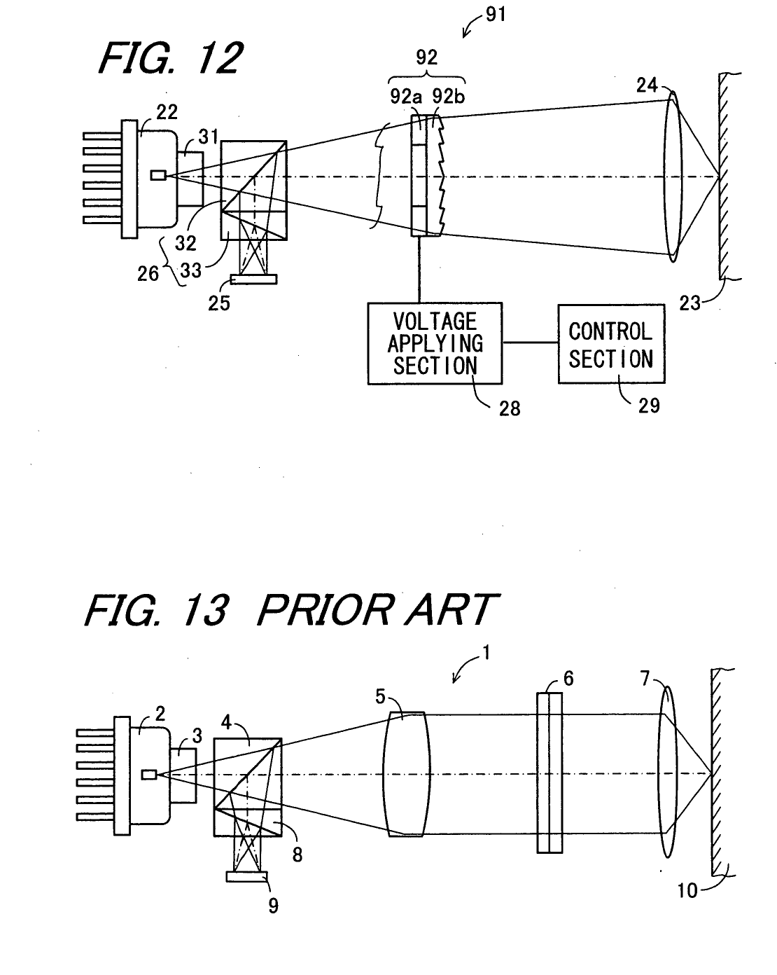

FIG. 12 is a sectional view showing a schematic configuration of an optical head 91 according to a fourth embodiment of the invention. The optical head 91 according to the present embodiment is similar to the optical head 81 according to the third embodiment, so that the corresponding components will be denoted by the same reference numerals, and descriptions thereof will be omitted. In the optical head 91 according to the fourth embodiment, a liquid crystal element 92a and a coupling lens 92b that is a Fresnel lens are provided integrally with each other to constitute a phase compensation imparting section 92. The liquid crystal element 92a is disposed between the coupling lens 92b and the semiconductor laser element 22 that is the light source, more concretely between the coupling lens 92b and the optical system 26.

The liquid crystal element 92a included in the phase compensation imparting section 92 is similar to the liquid crystal element 82a provided in the optical head 81 according to the third embodiment, so that descriptions thereof will be omitted. The coupling lens 92b serving as a diffusing angle adjusting element included in the phase compensation imparting section 92 is a lens for adjusting the diffusing angle of incident light similar to the coupling lens 82b according to the third embodiment, but a lens surface thereof is a Fresnel surface.

Since the coupling lens 92b of the phase compensation imparting section 92 provided in the optical head 91 according to the present embodiment is a Fresnel lens having a Fresnel surface, the lens can be provided with a small thickness. Consequently, it is possible to make the optical head 91 more compact.

In a disk reproducing apparatus having the optical head according to the invention as described above, a difference in the amount of phase change in a light spot attributable to the angle of incidence of light can be reduced to allow an improvement of recording and reproduction characteristics of an optical recording medium.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical head in which an optical recording medium is irradiated with light to record information thereon and/or reproduce information therefrom, comprising:
a light source for emitting light;
an objective lens for converging the light emitted by the light source on an optical recording medium;
a liquid crystal element provided on an optical path of diffuse light between the light source and an objective lens, the liquid crystal element being divided to have a plurality of divisions;
a voltage applying section for applying a voltage to the plurality of divisions of the liquid crystal element to change the refractive index of the divisions; and
a control section for controlling the operation of the voltage applying section which applies a voltage to the divisions of the liquid crystal element to adjust the amount of phase compensation imparted to light incident on each of the divisions of the liquid crystal element such that a spot formed by light transmitted by the liquid crystal element undergoes a phase change that is uniform in the spot.

2. The optical head of claim 1, further comprising a diffusing angle adjusting element for adjusting the diffusing angle of light incident thereon, and wherein the diffusing angle adjusting element is disposed between the light source and the objective lens.

3. The optical head of claim 2, wherein the liquid crystal element is disposed between the diffusing angle adjusting element and the objective lens.

4. The optical head of claim 2, wherein the liquid crystal element is disposed between the diffusing angle adjusting element and the light source.

5. The optical head of claim 4, wherein the liquid crystal element and the diffusing angle adjusting element are provided integrally with each other.

6. The optical head of claim 5, wherein the diffusing angle adjusting element is a Fresnel lens.

7. The optical head of claim 1, wherein the liquid crystal element includes a transparent electrode in each of the divisions.

8. The optical head of claim 1, wherein the direction in which the plurality of divisions of the liquid crystal element are arranged is in parallel with a radial direction of an optical recording medium in a recording or reproducing state.

9. The optical head of claim 1, wherein the light source emits laser light having a wavelength of 780 nm, and the objective lens has a numerical aperture NA of 0.45.

10. A disk reproducing apparatus comprising the optical head of claim 1.
